(19) United States
(12) Patent Application Publication
(10) Pub. No.: US 2009/0305142 A1
(43) Pub. Date: Dec. 10, 2009

(54) Electrode Grid

(75) Inventors: Friedrich Kramm, Buedingen (DE); Harald Niepraschk, Buedingen (DE); Hans Warlimont, Freigericht (DE); Thomas Hofmann, Dresden (DE)

Correspondence Address: MICHAEL L. DUNN, SIMPSON & SIMPSON, PLLC, 5555 MAIN STREET, WILLIAMSVILLE, NY, 14221, US

(73) Assignees: Deutsche EXIDE GmbH, Buedingen (DE); DSL Dresden Material-Innovation GmbH, Dresden (DE)

(21) Appl. No.: 11/990,220

(22) PCT Filed: Aug. 7, 2006
(86) PCT No.: PCT/EP2006/065115

§ 371 Date: Jul. 24, 2009

(30) Foreign Application Priority Data
Aug. 10, 2005 (DE) 102005038064.6

(51) Int. Cl. H01M 4/73

(52) U.S. Cl. 429/245

(57) ABSTRACT

The present invention relates to an electrode grid for a lead accumulator, comprising a grid substrate (1) and a coherent, galvanically deposited, multi-layer coating (2) on the grid substrate (1), wherein the grid substrate is produced from lead or lead alloy and the multi-layer coating comprises at least two layers which differ in respect of their composition, of which one layer (A) is produced by galvanic deposit of pure lead and one layer (B) which starting from the grid substrate is arranged over the layer (A) is produced by galvanic deposit of lead with at least 0.5% by weight and at most 2.0% by weight of tin.

### BACKGROUND OF THE INVENTION

The invention concerns electrode grids which are used as accumulator electrodes for lead accumulators.

Known electrode grids for lead accumulators are produced from fine lead or lead alloys such as for example lead-tin alloys or lead-calcium-tin alloys. Production is predominantly effected using a chill casting process or belt casting process using fusible lead alloys or in a expanded metal or stamping process using lead sheets. With those processes it is not possible to specifically and targetedly set a different alloying concentration and a different grain structure in the outer layers of the electrode grid, from in the interior thereof in order thereby to influence the corrosion characteristics. Those processes are also not suitable for producing an outer layer which, by virtue of its chemical composition and structure, permits the formation of a reaction layer which, by virtue of its corrosion characteristics, on the one hand promotes a firmly adhering connection to the active mass of the accumulator and thus reduces the tendency to premature failure of the accumulator due to detachment of the active mass from the electrode grid while on the other hand reducing corrosion to such an extent that an adequate service life for the electrode grid is achieved.

A further disadvantage of those processes is that it is not possible to specifically produce surface roughness of defined magnitude in order in addition to produce a firmly adhering mechanical connection to the active mass in a controlled fashion.

A further disadvantage of the known electrode grids which are produced using the aforementioned processes is that they can involve inadequate mechanical stability.

### BRIEF SUMMARY OF THE INVENTION

The invention includes an electrode grid for a lead accumulator. The accumulator includes a grid substrate (1) and a coherent, galvanically deposited, multi-layer coating (2) on the grid substrate (1), wherein

the grid substrate is produced from lead or lead alloy and

the multi-layer coating comprises at least two layers which differ in respect of their composition, of which

one layer (A) of a galvanically deposited pure lead and

one layer (B) which starting from the grid substrate is above the layer (A) of galvanically deposited lead containing at least 0.5% by weight and at most 2.0% by weight of tin.

Desirably the multilayer coating further has at least one additional layer selected from:

a) layer (C) that is galvanically deposited copper,

b) layer (D) consisting essentially of a galvanic deposit of lead at most 1.0% by weight of tin, and

c) layer (E) that is galvanic deposit of lead containing 0.1% through 1.0% by weight of silver and up to 1% by weight of silver.

The invention further includes a battery or accumulator including at least one electrode incorporating the electrode grid of the invention

### BRIEF DESCRIPTION OF THE SEVERAL VIEWS OF THE DRAWINGS

FIG. 1 diagrammatically shows a section through an electrode grid according to the invention produced using the drum casting process, with 2 galvanically deposited layers A and B, and

FIG. 2 diagrammatically shows a section through an electrode grid according to the invention produced using the expanded metal process, with 4 galvanically deposited layers with different layer sequences which are suitable in accordance with the invention.

### DETAILED DESCRIPTION OF THE INVENTION

The object of the present invention is to provide an electrode grid with improved resistance to corrosion, particularly when used as the positive accumulator electrode, improved mechanical stability, improved cycle stability and improved deep-discharge resistance.

That object is attained by an electrode grid for a lead accumulator, comprising a grid substrate and a coherent, galvanically deposited, multi-layer coating on the grid substrate, wherein the grid substrate is produced from lead or lead alloy and the multi-layer coating comprises at least two layers which differ in respect of their composition, of which one layer (A) is produced by galvanic deposit of pure lead and a further layer (B) which starting from the grid substrate is arranged over the layer (A) is produced by galvanic deposit of lead with at least 0.5% by weight and at most 2.0% by weight of tin.

The galvanic deposit of metal layers on the grid substrate has a series of advantages over other known coating processes. The galvanic deposit of a plurality of layers is suitable for economic mass production of grid electrodes at comparatively low cost levels and with a high throughput. A process which is suitable for galvanic coating is for example one in which a lead grid strip is passed continuously through a galvanic bath or a plurality of successively arranged galvanic baths and the metals contained in the baths are electrochemically deposited on the substrate. Such a process is disclosed for example in WO 02/057515 A2. For depositing the metals the lead grid strip is passed as a cathode through the galvanic baths. Connecting the lead grid strip as an anode is suitable for example for modifying the metal surface such as for example for etching surface regions (roughening up) or for degreasing.

A further advantage of galvanic deposit of the metal layers on the grid substrate is that the entire surface of the grid substrate can be completely coated throughout, which is not guaranteed when using plating processes as are described for example in U.S. Pat. No. 4,906,540. Furthermore the galvanic deposit of the metal layers on the grid substrate affords the further advantage that the galvanic deposit produces a very homogeneous coating which is not porous. In the galvanic deposit procedure, a large number of finely distributed grain boundaries is formed so that corrosive attack takes place in the form of shell corrosion and not predominantly in the form of corrosion along a few grain boundaries proceeding into the depth of the grid, as in the case of grids which are produced by chill casting. In shell corrosion corrosive attack takes place distributed uniformly over the entire surface from the outside inwardly. Intergranular corrosion has the result that individual large grains are removed from the surface of the metal and corrosion proceeds very rapidly into the depth of the metal at locally delimited locations. Shell corrosion therefore progresses considerably more slowly and more uniformly than intergranular corrosion.

A further advantage of galvanic deposit of the layers according to the invention is that it makes it easily possible to specifically provide surface roughness on the surface of the outermost layer (B). Surface roughness is advantageous as it improves the adhesion of the active mass to the electrode grid. The particular structural state produced by the galvanic process and the surface roughness on the outermost layer (B), both in formation of the plates and also in operation of the electrode grid, promote the formation of a thin corrosion layer at the outermost surface, which provides for a good electron transition between the electrode grid and the active mass.

The layer (A) according to the invention which is produced by galvanic deposit of pure lead represents a corrosion barrier in relation to the grid substrate by virtue of its very high resistance to corrosion.

The layer (B) which is provided in accordance with the invention and which starting from the grid substrate is arranged over the layer (A) and which is produced by galvanic deposit of lead comprising at least 0.5% by weight and at most 2.0% by weight of tin is preferably always applied as the outermost layer, as considered from the grid substrate, independently of the number of layers. The high tin content of that layer promotes the formation of a thin tin-rich corrosion layer at the outermost surface and thus the electron transition to the active mass which is applied directly thereto. Furthermore the layer (B) can improve the mechanical adhesion of the active mass, by the provision of surface roughness.

In a preferred embodiment of the invention the multi-layer coating further has one or more layers (C) which is/are produced by galvanic deposit of copper. Particularly preferably the multi-layer coating has precisely one such layer (C) of copper.

The provision of one or more copper layers in the multi-layer coating enhances the electrical conductivity of the overall grid as a current conductor. The copper layer (C) also improves the mechanical stability of the electrode grid according to the invention. A copper layer (C) can advantageously be deposited directly as the first layer on the grid substrate by a galvanic process. Alternatively or additionally it is possible to provide one or more copper layers (C) between the lead layers. Particularly preferably, the multi-layer coating according to the invention includes only one copper layer (C).

In a further preferred embodiment of the electrode grid according to the invention the multi-layer coating further has a layer (D) which is produced by galvanic deposit of lead having at most 1.0% by weight of tin. Preferably the tin content of that layer (D) is at least 0.1% by weight and at most 0.9% by weight, particularly preferably at least 0.3% by weight and at most 0.7% by weight of tin. That layer (D) with a tin content which is lower than that of the outermost layer (B) promotes corrosion protection for the multi-layer coating of the electrode grid according to the invention.

In a further preferred embodiment of the electrode grid according to the invention the multi-layer coating further has a layer (E) which is produced by galvanic deposit of lead having at least 0.1% by weight and at most 1.0% by weight of silver and optionally with additionally at least 0.1% by weight and at most 1.0% by weight of tin. Preferably the silver-bearing layer (E) has not more than 0.6% by weight of silver and quite particularly preferably not more than 0.3% by weight of silver. The silver-bearing layer (E) promotes corrosion protection and increases the mechanical stability of the electrode grid.

Advantageous multi-layer coatings of the electrode grid according to the invention, starting from the grid substrate, have one of the following layer sequences:

(A)-(B), (C)-(A)-(B), (A)-(E)-(B), (A)-(D)-(B),
(D)-(A)-(B), (E)-(A)-(B), (A)-(C)-(D)-(B),
(A)-(E)-(D)-(B), (A)-(C)-(D)-(B),
(D)-(A)-(E)-(B), (D)-(C)-(A)-(B), (E)-(A)-D)-(B),
(C)-(D)-(A)-(B), (E)-(C)-(A)-(B), (C)-(A)-(E)-(B),
(E)-(D)-(A)-(B), (D)-(E)-(A)-(B).

In accordance with the invention the lead-tin layer (B) with a high tin content is always the outermost layer of the multi-layer coating. For the above-specified purpose of that layer it is advantageous if the tin content in that layer is at least 0.5% by weight and at most 2.0% by weight, preferably at least 0.8% by weight and at most 1.5% by weight.

The multi-layer coating on the electrode grid according to the invention has at least two layers which are different in respect of their composition. The grid advantageously has 2, 3 or 4 layers. The multi-layer coating should have not more than 6, preferably at most 5, quite particularly preferably at most 4 layers which are different in respect of their composition. A number of layers of more than 4 layers is already very complicated and expensive to produce in terms of process engineering. The production of an excessively high number of layers is therefore cost- and time-intensive and economically not meaningful.

In a further preferred embodiment of the electrode grid according to the invention the multi-layer coating is of an overall thickness in the range of between 100 and 1000 μm, preferably between 120 and 750 μm, particularly preferably between 150 and 500 μm. With that layer thickness, adequate corrosion protection and long durability of the electrode grid is guaranteed, for a long service life for the lead accumulator. In addition the layer thickness in the above-specified range imparts high mechanical stability to the grid substrate. Smaller overall thicknesses for the multi-layer coating reduce the resistance to corrosion and thus the service life and mechanical stability of the electrode grid. Greater overall thicknesses for the multi-layer coating do not afford any further advantage in regard to corrosion protection in consideration of the usual service life of a lead accumulator and are cost- and time-intensive and thus uneconomical in regard to their production.

The individual layers of the multi-layer coating, which differ in respect of their composition, are each advantageously of a thickness in the range of between 30 and 500 μm, preferably between 40 and 400 μm, particularly preferably between 50 and 300 μm. Those individual layer thicknesses are sufficient for the respective layers to be able to implement the implement the properties and functions attributed to them, as are described hereinbefore. Excessively small layer thicknesses can have the result that the individual layers cannot adequately perform their functions, such as for example corrosion protection, mechanical stability and so forth. Greater individual layer thicknesses are not required for performing the respective functions of the layers and are uneconomical in terms of their production.

The grid substrate of the electrode grid according to the invention is advantageously produced from fine lead, a lead-tin alloy, a lead-tin-silver alloy, a lead-calcium-tin alloy or a lead-antimony alloy. Usually the grid substrate perpendicularly to the plane of the grid is of a thickness of between 0.3 and 8 mm, preferably between 0.4 and 5 mm, particularly preferably between 0.5 and 3 mm.

The grid substrate of the electrode grid according to the invention can be produced in various ways. In one embodiment the grid substrate is produced in the form of a continuous grid strip from cast or rolled lead material strip with the grid structure being stamped out. In an alternative embodiment the grid substrate is produced in the form of a continuous grid strip in accordance with the drum casting process or the casting rolling process. In a further alternative embodiment the grid strip is produced in the form of a continuous grid strip from cast or rolled lead material strip with stamping and subsequent stretching in accordance with the expanded metal process. Those processes have the advantage that they afford a continuous grid strip which can be coated highly economically and in a time-saving fashion in a continuous galvanisation process with a plurality of successively arranged galvanic baths.

An advantage of the electrode grid according to the invention is that it can be produced continuously and inexpensively using a grid strip as the substrate, produced using the concast or expanded metal process. The disadvantages of the conventional substrates alone are, depending on the respective alloy, a low level of mechanical stability, poor electrical conductivity and, depending on the respective production process and alloy involved, low corrosion stability and poor mechanical adhesion of the active mass. Those disadvantages can be overcome by the multi-layer, galvanically produced coating according to the invention.

A further advantage of the electrode grid according to the invention is that accumulators which are produced with the electrode grid according to the invention achieve a high level of cycle stability. Cycle stability means that the accumulator withstands very frequent charging and discharging processes as occur for example in wheelchairs, power sweepers and electrically driven stacking lift trucks. Tests in respect of cycle stability of accumulators are described in the standard IEC 60254, Part 1.

Yet a further advantage of the electrode grid according to the invention is that accumulators which are produced with the electrode grid according to the invention achieve a very high degree of deep-discharge resistance. Deep-discharge resistance means that the accumulator withstands discharges below the prescribed discharge cut-off voltage, as can occur for example in the travel mode in the case of wheelchairs, emergency power supplies and electrically operated fork lift trucks, if that is not prevented by electrical shut-down. Such discharges basically signify damage to the lead electrode, in particular the positive one. Tests in respect of deep-discharge resistance of accumulators are described in IEC 61056, Part 1.

Yet a further advantage of the electrode grid according to the invention is that it has good corrosion resistance, high mechanical stability, good electrical conductivity and good electrical transition from the grid to the active mass. In addition the electrode grid according to the invention is distinguished by good mechanical adhesion of the active mass by virtue of specifically induced roughness of the surface.

It is therefore possible to achieve optimum properties for a grid by selection of the nature and succession of the layers in the multi-layer coating of the electrode grid according to the invention.

The electrode grid according to the invention is quite particularly suitable as a grid of the positive electrode (but also the negative electrode) as the positive electrode is exposed to particularly high loading levels, in particular in relation to corrosion. Corrosion of the positive grid occurs in particular upon overcharging of the accumulator and in cyclic use by virtue of the charging methods and also in steady-state operation due to permanent continuous charging of the accumulator, in particular at high temperatures.

The electrode grid according to the invention is suitable for sealed accumulators and for lead accumulators with liquid or gel-like electrolytes or electrolytes bound in non-woven fabric, for cyclic, steady-state and starter applications.

Further advantages, features and embodiments are apparent from the description of the accompanying drawings.

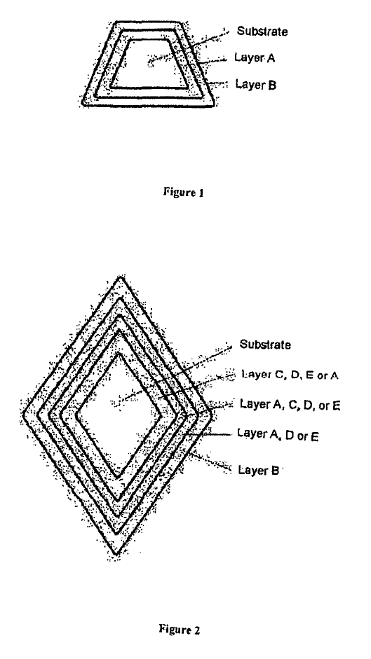

FIG. 1 diagrammatically shows a section through an electrode grid according to the invention produced using the drum casting process. In this embodiment by way of example the substrate comprises a lead-calcium-tin alloy with 0.1% by weight of calcium, 0.2% by weight of tin and the balance lead. Two layers (A) and (B) are galvanically deposited on the substrate. In this embodiment by way of example the layer (A) comprises pure lead (fine lead) and the layer (B) comprises lead with 1.5% by weight of tin. The two-layer coating is of an overall thickness of 400 μm, with the layer (A) being of a thickness of 250 μm and the layer (B) being of a thickness of 150 μm.

FIG. 2 diagrammatically shows a section through an electrode grid according to the invention produced using the expanded metal process. In this embodiment by way of example the substrate comprises a lead-calcium-tin alloy with 0.06% by weight of calcium, 0.1% by weight of tin and the balance lead. Four layers are galvanically deposited on the substrate, wherein the first layer on the substrate can be a layer (C), (D), (E) or (A), the second layer can be a layer (A), (C), (D) or (E), the third layer can be a layer (A), (D) or (E) and the fourth layer is a layer (B). In the four-layer coating the layers (A), (B), (D) and (E) are each of thicknesses of about 150 μm while the layer (C) is of a thickness of about 50 μm.

What is claimed is:

1-18. (canceled)

19. An electrode grid for a lead accumulator, comprising a grid substrate (1) and a coherent, galvanically deposited, multi-layer coating (2) on the grid substrate (1), wherein
the grid substrate is produced from lead or lead alloy and
the multi-layer coating comprises at least two layers which differ in respect of their composition, of which
one layer (A) of a galvanically deposited pure lead and
one layer (B) which starting from the grid substrate is above the layer (A) of galvanically deposited lead containing at least 0.5% by weight and at most 2.0% by weight of tin.

20. An electrode grid as set forth in claim 19 wherein layer (B) always represents the outermost layer as considered from the grid substrate independently of the number of layers.

21. An electrode grid as set forth in claim 19 wherein the multi-layer coating further has at least one additional layer selected from the group consisting of:
a) layer (C) that is galvanically deposited copper,
b) layer (D) consisting essentially of a galvanic deposit of lead at most 1.0% by weight of tin,
c) layer (E) that is galvanic deposit of lead containing 0.1% through 1.0% by weight of silver and up to 1% by weight of silver.

22. An electrode grid as set forth in claim 19 wherein the multi-layer coating starting from the grid substrate has the layer sequence (A)-(B).

23. An electrode grid as set forth in claim 21 wherein the multi-layer coating, starting from the grid substrate has a layer sequence selected from the group consisting of (C)-(A)-(B), (A)-(E)-(B), (A)-(D)-(B), (D)-(A)-(B), (E)-(A)-(B), (A)-(C)-(D)-(B), (A)-(E)-(D)-(B), (A)-(C)-(D)-(B), (D)-(A)-(E)-(B), (D)-(C)-(A)-(B), (E)-(A)-D)-(B), (C)-(D)-(A)-(B), (E)-(C)-(A)-(B), (C)-(A)-(E)-(B), (E)-(D)-(A)-(B), AND (D)-(E)-(A)-(B).

24. An electrode grid as set forth in claim 19 wherein layer (B) is produced by galvanic deposit of lead having at least 0.8% by weight and at most 1.5% by weight of tin.

25. An electrode grid as set forth in claim 21 wherein layer (B) is produced by galvanic deposit of lead having at least 0.8% by weight and at most 1.5% by weight of tin.

26. An electrode grid as set forth in claim 19 wherein the multi-layer coating has 2 through 6 layers of different composition.

27. An electrode grid as set forth in claim 19 wherein the multi-layer coating has 4 through 6 layers of different composition.

28. An electrode grid as set forth in claim 19 wherein the multi-layer coating has 2 through 3 layers of different composition.

29. An electrode grid as set forth in claim 19 wherein the multi-layer coating has 4 layers of different composition.

30. An electrode grid as set forth in claim 19 wherein the multi-layer coating is of an overall thickness in the range of between 100 and 1000 μm.

31. An electrode grid as set forth in claim 19 wherein the multi-layer coating is of an overall thickness in the range of between 120 and 750 μm.

32. An electrode grid as set forth in claim 19 wherein the multi-layer coating is of an overall thickness in the range of between 150 and 500 μm.

33. An electrode grid as set forth in claim 19 wherein the individual layers of the multi-layer coating are each of a thickness in the range of between 30 and 500 μm.

34. An electrode grid as set forth in claim 19 wherein the individual layers of the multi-layer coating are each of a thickness in the range of between 40 and 400 μm.

35. An electrode grid as set forth in claim 19 wherein the individual layers of the multi-layer coating are each of a thickness in the range of between 30 and 500 μm., particularly preferably between 50 and 300 μm.

36. An electrode grid as set forth in claim 19 wherein the layers of the multi-layer coating are not porous.

37. An electrode grid as set forth in claim 19 wherein the grid substrate is fine lead, a lead-tin alloy, a lead-tin-silver alloy, a lead-calcium-tin alloy or a lead-antimony alloy.

38. An electrode grid as set forth in claim 19 wherein the grid substrate perpendicularly to the plane of the grid is of a thickness of between 0.3 and 8 mm.

39. An electrode grid as set forth in claim 19 wherein the grid substrate is in the form of a continuous grid strip from cast or rolled lead material strip with the grid structure being stamped out.

40. An electrode grid as set forth in claim 19 wherein the grid substrate is a continuous grid strip stamped from cast or rolled lead material strip and subsequent stretching in accordance with an expanded metal process.

41. An electrode grid as set forth in claim 19 wherein the individual layers of the multi-layer coating are each of a thickness in the range of between 30 and 500 μm.

42. A lead accumulator or lead battery wherein at least one electrode comprises an electrode grids as set forth in claim 19.
